(19) United States
(12) Patent Application Publication
(10) Pub. No.: US 2004/0088532 A1
(43) Pub. Date: May 6, 2004

(54) Method of configuring a virtual FD drive in computer by means of SRAM

(75) Inventor: Yung-Shun Chuang, Hsin-Tien City (TW)

Correspondence Address: RABIN & BERDO, P.C., Suite 500, 1101 14 Street, N.W., Washington, DC, 20005, US

(73) Assignee: AAEON TECHNOLOGY INC., Hsin-Tien City (TW)

(21) Appl. No.: 10/284,133

(22) Filed: Oct. 31, 2002

(51) Int. Cl. G06F 9/00

(52) U.S. Cl. 713/1

(57) ABSTRACT

A method of configuring a virtual floppy disk (FD) drive in computer after a power on self test (POST) has been performed is provided. The method comprising inserting a BIOS extension for serving ISR of a normal FD drive; processing SRAM; updating CMOS data of the BIOS extension; simulating the SRAM as the virtual FD drive; and changing the normal FD drive into another FD drive. The invention has advantages of higher reliability and faster access speed. Further, the invention is suitable for storing startup programs or critical data.

### FIELD OF THE INVENTION

The present invention relates to start of computer and more particularly to a method of configuring a virtual floppy disk (FD) drive in a computer with improved characteristics.

### BACKGROUND OF THE INVENTION

A startup disk implemented as a FD is required to start a computer (e.g., personal computer (PC) or industrial computer). Conventionally, a MS-DOS (Microsoft Disk Operating System) is responsible for starting the computer once powered on. In a typical procedure, a user may insert a startup disk into a FD drive. Next, MS-DOS reads startup programs from the startup disk for starting the computer. The computer will be started if the procedure goes well. However, in an undesired case the computer will not be started due to damage of the startup disk or an invasion of virus into the computer. Once the above undesired case occurred, there is still no way to start the computer if a backup of the startup disk is not ready.

Thus, it is desirable to provide an improved method of configuring a virtual FD drive in a computer in addition to the normal FD drive in order to overcome the above drawbacks of the prior art.

### SUMMARY OF THE INVENTION

It is therefore an object of the present invention to provide a method of configuring a virtual floppy disk (FD) drive in a computer after a power on self test (POST) has been performed, the method comprising the steps of A. reading a capacity of a static random access memory (SRAM); B. reading a jumper setting of the SRAM; C. determining whether the SRAM is enabled; D. if the determination in the step C is positive, updating complementary metal oxide semiconductor (CMOS) data of the computer based on the jumper setting, setting a SRAM virtual FD drive as a second FD drive for startup by the SRAM, and integrating the updating and the setting in a memory device to logically change the setting of a normal FD drive; E. fetching an interrupt service routine (ISR) address of the normal FD drive by the memory device and taking it as an ISR address of the SRAM virtual FD drive; F. directing all instructions to the ISR of the SRAM virtual FD drive for being processed; and G. loading startup programs into an operating system.

In one aspect of the present invention, the ISR comprises the steps of a. processing instructions about FD drive or hard disk (HD) drive wherein all instructions are intercepted by the ISR of the SRAM virtual FD drive; b. determining whether the intercepted instruction is a FD instruction; c. if the determination in the step c is positive, jumping to the step e; d. sending the instruction to the ISR for subsequent processing; e. determining whether the instruction is a SRAM instruction; and f. if the determination in the step e is positive performing an input/output (I/O) processing by the SRAM virtual FD drive else performing a processing of FD I/O.

The above and other objects, features and advantages of the present invention will become apparent from the following detailed description taken with the accompanying drawings.

### BRIEF DESCRIPTION OF THE DRAWINGS

FIG. 1 is a flow chart illustrating a process of configuring a virtual FD drive in a computer according to the invention; and

FIG. 2 is a flow chart illustrating a process performed by an interrupt service routine (ISR) according to the invention.

### DETAILED DESCRIPTION OF THE PREFERRED EMBODIMENTS

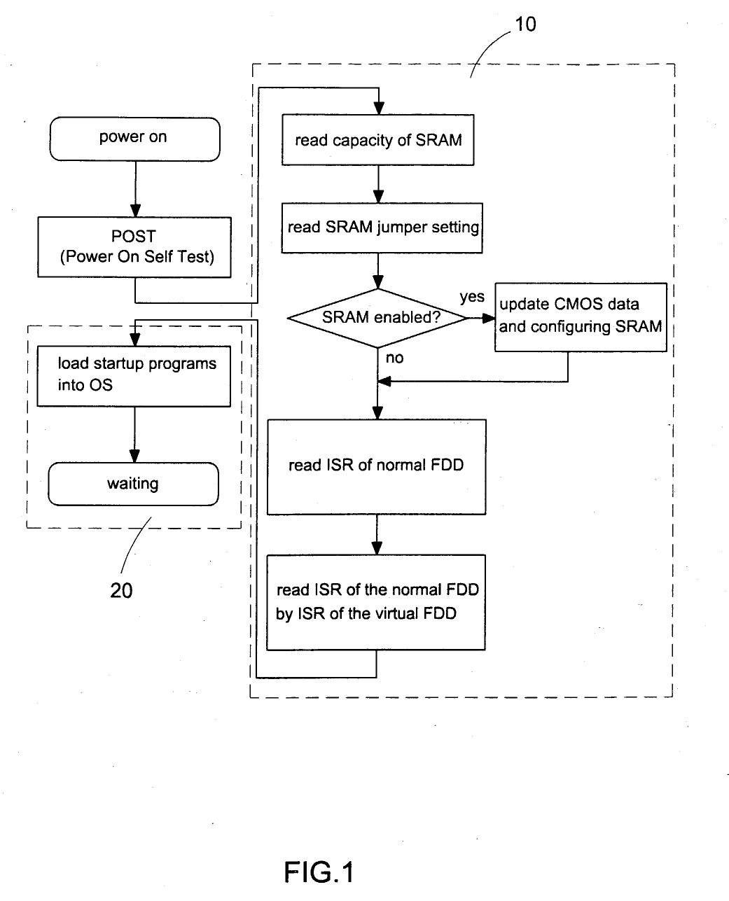

Referring to FIG. 1, a process of configuring a virtual FD drive in a computer (e.g., PC or industrial computer) in accordance with the invention comprising the following steps. First, turn on the computer. Next, a power on self test (POST) is performed by a basic input output system (BIOS) of the computer. During the POST, the BIOS will scan the computer for searching existing read only memory (ROM) devices such as network adapter or small computer system interface (SCSI) card. Once one or more ROM devices are found, ROM initial codes are loaded. In step 10, a plurality of sub-steps are performed. For example, first reads a capacity of a static random access memory (SRAM). The capacity of the SRAM is either 256 KB or 54 KB. Next, read jumper setting of the SRAM. A determination is then made whether the SRAM is enabled in which an embedded BIOS extension of the BIOS will simulate the SRAM as either 360 KB or 1.44 MB FD drive once the SRAM is enabled. If the determination is yes, complementary metal oxide semiconductor (CMOS) data of the computer will be updated based on the jumper setting. Also, a SRAM virtual FD drive is set as another FD drive A or B by the SRAM. Above settings will be integrated in the BIOS extension to logically change setting of the normal FD drive. For example, the SRAM virtual FD drive is taken as drive A and the normal FD drive A is taken as drive B. Alternatively, the SRAM virtual FD drive is taken as drive B and the normal FD drive B is taken as drive A. Thus, two FDs are obtained in the computer in which the SRAM virtual FD drive is for startup. Then the BIOS extension will fetch an ISR address of the normal FD drive and take it as an ISR address of the SRAM virtual FD drive. Moreover, replace ISR of the normal FD drive by ISR of the virtual FD drive. Thereafter, all instructions such as read, write, format, etc. will be directed to the ISR of the SRAM virtual FD drive for being processed by MS-DOS.

In step 20, a couple of sub-steps are performed. For example, a loading of startup programs into an operating system (OS) (e.g., MS-DOS). Finally, the computer is waiting.

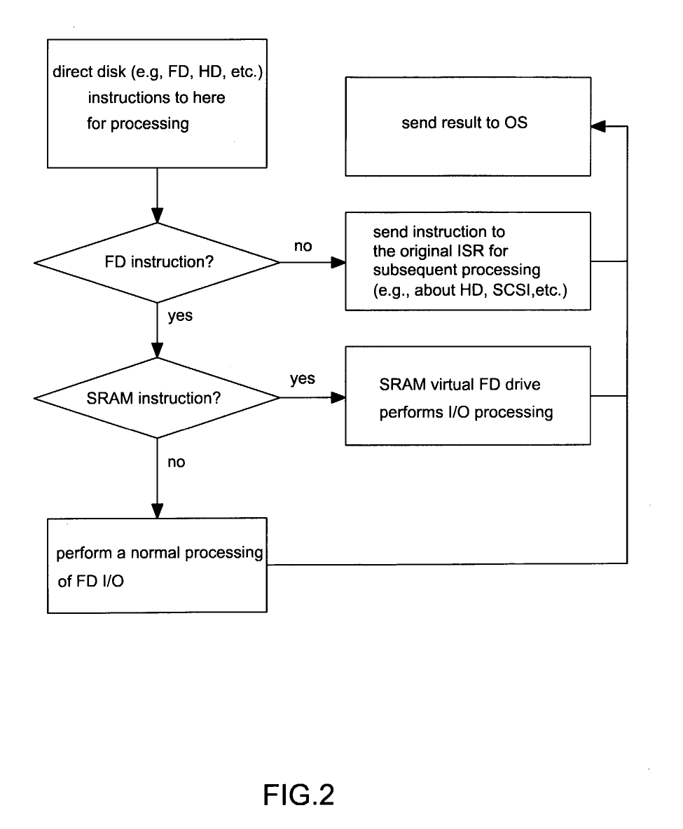

Referring to FIG. 2, a process performed by the ISR is illustrated. After the BIOS extension has finished the setting of the ISR of the SRAM virtual FD drive, the OS will process instructions about FD drive or hard disk (HD) drive in which all such instructions are intercepted by the ISR of the SRAM virtual FD drive. A determination is then made as to whether the intercepted instruction is a FD instruction. If yes, the process goes on to determine whether it is a SRAM instruction. Otherwise, the instruction is sent to the original ISR for subsequent processing (e.g., about HD, SCSI, or the like). Also, if the SRAM instruction determination is yes, the SRAM virtual FD drive will perform an input/output (I/O) processing. Otherwise, the process determines that the instruction is a FD instruction. Next, a normal processing of FD I/O is performed. Finally, any result is sent to the OS.

In brief, the invention utilizes the SRAM for performing reading, writing, etc. Hence, there is no need for compact disc-recordable (CD-R) or any of other applications to read or write files. Thus, the invention, as compared to the conventional FD drive, has advantages of higher reliability, faster access speed, safety, and space saving. Most importantly, the invention is particularly suitable for storing startup programs or critical data.

While the invention has been described by means of specific embodiments, numerous modifications and variations could be made thereto by those skilled in the art without departing from the scope and spirit of the invention set forth in the claims.

What is claimed is:

1. A method of configuring a virtual floppy disk (FD) drive in a computer after a power on self test (POST) has been performed, the method comprising the steps of:
A. reading a capacity of a static random access memory (SRAM);
B. reading a jumper setting of the SRAM;
C. determining whether the SRAM is enabled;
D. if the determination in the step C is positive, updating complementary metal oxide semiconductor (CMOS) data of the computer based on the jumper setting, setting a SRAM virtual FD drive as a second FD drive for startup by the SRAM, and integrating the updating and the setting in a memory device to logically change the setting of a normal FD drive;
E. fetching an interrupt service routine (ISR) address of the normal FD drive by the memory device and taking it as an ISR address of the SRAM virtual FD drive;
F. directing all instructions to the ISR of the SRAM virtual FD drive for being processed; and
G. loading startup programs into an operating system.

2. The method of claim 1, wherein the ISR comprises the steps of:
a. processing instructions about FD drive or hard disk (HD) drive wherein all instructions are intercepted by the ISR of the SRAM virtual FD drive;
b. determining whether the intercepted instruction is a FD instruction;
c. if the determination in the step c is positive, jumping to the step e;
d. sending the instruction to the ISR for subsequent processing;
e. determining whether the instruction is a SRAM instruction; and
f. if the determination in the step e is positive performing an input/output (I/O) processing by the SRAM virtual FD drive else performing a processing of FD I/O.

3. The method of claim 1, wherein the computer is a personal computer (PC) or industrial computer.

4. The method of claim 1, wherein the memory device is an embedded basic input output system (BIOS) extension of BIOS.
